(19) United States
(12) Patent Application Publication
(10) Pub. No.: US 2013/0193837 A1
(43) Pub. Date: Aug. 1, 2013

(54) PHOSPHOR PLATE, LIGHT EMITTING DEVICE AND METHOD FOR MANUFACTURING PHOSPHOR PLATE

(71) Applicant: SHARP KABUSHIKI KAISHA, Osaka (JP)

(72) Inventors: Masato OHNO, Osaka-shi (JP); Tatsuya RYOWA, Osaka-shi (JP); Kazunori ANNEN, Osaka-shi (JP); Makoto IZUMI, Osaka-shi (JP); Yasutaka KUZUMOTO, Osaka-shi (JP); Kimiko MIEDA, Osaka-shi (JP)

(73) Assignee: SHARP KABUSHIKI KAISHA, Osaka (JP)

(21) Appl. No.: 13/748,936

(22) Filed: Jan. 24, 2013

(30) Foreign Application Priority Data
Jan. 26, 2012 (JP) 2012-014043
Feb. 22, 2012 (JP) 2012-035692

(51) Int. Cl. H05B 33/12; B32B 15/00

(52) U.S. Cl. CPC H05B 33/12; B32B 15/00
USPC 313/498; 427/157; 428/690

(57) ABSTRACT

A phosphor plate includes a base material, a phosphor and a scattering material. The phosphor absorbs primary light emitted by a light emitting element and emits secondary light having a wavelength longer than a wavelength of the primary light. The scattering material scatters the primary light and the secondary light. An average distance from one surface of the phosphor plate to the phosphor is longer than an average distance from the one surface to the scattering material. With such a configuration, there are provided a phosphor plate having the enhanced extraction efficiency of light emitted by a phosphor, a light emitting device including the phosphor plate, and a method for manufacturing the phosphor plate.

This nonprovisional application is based on Japanese Patent Application No. 2012-14043 filed on Jan. 26, 2012 and No. 2012-35692 filed on Feb. 22, 2012 with the Japan Patent Office, the entire contents of which are hereby incorporated by reference.

### BACKGROUND OF THE INVENTION

1. Field of the Invention

The present invention relates to a light emitting device used in lighting equipment and a display, and particularly to a phosphor plate containing a phosphor excited by light outputted from a light source, a light emitting device using the phosphor plate, and a method for manufacturing the phosphor plate. In addition, the present invention relates to a light emitting device used in lighting equipment and a display, and particularly is suitable for a light emitting device using light directly outputted from a light source and a phosphor excited by a part of this light outputted from the light source.

2. Description of the Background Art

In recent years, as a light emitting device using a light emitting diode (hereinafter referred to as LED), an LED backlight for a liquid crystal display and an LED light bulb have received attention. The LED has excellent features such as power saving, long product life and small impact on the environment. A light emitting portion of the LED backlight and the LED light bulb emits a combination of light obtained as a result of wavelength conversion of a part of light from the LED by a phosphor and light from the LED that is not subjected to wavelength conversion by the phosphor, and thereby the light emitting portion can emit various types of light different from the original light from the LED. Such a light emitting device has been greatly expected and developed as an alternative light emitting device to conventional lighting equipment and a conventional backlight for a display.

Generally, when the light emitting device is configured by an LED chip and a phosphor, there are various methods such as a first method for mixing the phosphor into a resin material and covering the LED chip with the material, a second method for directly applying the phosphor onto a light emitting surface of the LED chip, and a third method for putting a sheet containing the phosphor on the chip. Currently, the first method is adopted most frequently. In the case of the first and second methods, however, the sealing resin has a large thickness. Therefore, light from the LED element is absorbed by the sealing resin, which results in light loss. Or heat generated due to light emission by the LED affects the phosphor directly, and thus, depending on the type of the phosphor, the phosphor is degraded by the heat and the wavelength conversion efficiency or the light emission efficiency may be reduced.

For these reasons, the above-described third method receives attention. In the third method, a sheet-like phosphor plate obtained by mixing a phosphor into a resin and solidifying the resin at a place different from a place of the light emitting device, or a phosphor plate obtained by sandwiching a phosphor or a resin containing the phosphor between inorganic glasses, organic glasses or the like is used.

FIG. 6 is a cross-sectional view showing a light emitting device disclosed in PTL 1 (Japanese Patent Laying-Open No. 2007-123438). In FIG. 6, a light emitting device 600 includes a package 601 for housing an element, an inert gas 603 such as Ar and N₂ filled into package 601 and sealing an LED element 602, and a phosphor plate 604 arranged on the light extraction side of LED element 602 to cover inert gas 603. Phosphor plate 604 contains, in a base member such as silicone, a phosphor and a bubble functioning similarly to a scattering material and serving as a light travel direction conversion portion.

With such a configuration, the light extraction efficiency can be enhanced, high-intensity irradiation light can be obtained over a long period, and color unevenness can be improved.

In recent years, a light emitting device including a phosphor that is a nanocrystal (hereinafter referred to as nanocrystalline phosphor) and a light source emitting primary light that excites the phosphor has also been developed actively as a next-generation light emitting device that is expected to be power-saving, compact and high in intensity. Since the nanocrystal is used as the phosphor, enhancement of the light emission efficiency is expected as compared with conventional phosphors. The nanocrystalline phosphor is characterized in that, by changing a particle size of the nanocrystal, colors of emitted light can be freely controlled from blue (short wavelength) to red (long wavelength) due to the quantum size effect. By optimizing conditions for fabricating this nanocrystalline phosphor, variations in particle size distribution of the nanocrystal are eliminated and the nanocrystalline phosphor having a substantially uniform particle size is obtained. As a result, a light emission spectrum with a narrow half band width can be obtained.

One example of a light emitting device using such a nanocrystalline phosphor is disclosed in PTL 2 (Japanese Patent Laying-Open No. 2007-103512). FIG. 16 is a schematic cross-sectional view of a light emitting device 800 disclosed in PTL 2. This light emitting device 800 includes a light emitting element 802, a reflection member 803 and a wavelength conversion portion on a substrate 801. A common phosphor having an average particle size of 0.1 to 50 μm and a nanocrystalline phosphor having an average particle size of 10 nm or smaller are used as phosphors forming the wavelength conversion portion. Specifically, [(Sr, Ca, Ba, Mg)₁₀(PO₄)₆Cl₂:Eu] having an average particle size of 7 μm is used as a blue phosphor 804, [BaMgAl₁₀O₁₇:Eu, Mn] having an average particle size of 4 μm is used as a green phosphor 805, ZnAgInS₂ having an average particle size of 2.8 nm is used as a yellow phosphor 806, and ZnAgInS₂ having an average particle size of 3.8 nm is used as a red phosphor 807. With such a configuration, excellent white light having good color balance can be emitted efficiently.

### SUMMARY OF THE INVENTION

As for light emitting device 600 shown in FIG. 6 and disclosed in PTL 1, the phosphors and the bubbles are irregularly dispersed throughout phosphor plate 604. Therefore, many bubbles may be present on the light exit surface side of the phosphor plate when viewed with respect to a position of a certain phosphor. In this case, in light emitting device 600, light emitted from the phosphor and traveling toward the light exit surface side of the phosphor plate is scattered rearward by the scattering material, which generates light returning to the primary light entrance surface side of the phosphor plate. As a result, the light extraction efficiency is reduced.

Thus, the present invention has been made in light of the above-described problem and one object of the present invention is to provide a phosphor plate having the enhanced extraction efficiency of light emitted by a phosphor, a light emitting device including the phosphor plate, and a method for manufacturing the phosphor plate.

As for light emitting device 800 shown in FIG. 16 and disclosed in PTL 2, the wavelength conversion portion containing the nanocrystalline phosphor is located at the top surface and an upper surface thereof is exposed to the atmosphere. Since the nanocrystalline phosphor is originally vulnerable to oxygen and water, the uppermost phosphor may be directly exposed to the air and may be degraded. This leads to deterioration in performance of the light emitting device, and thus, this is a problem. Even if the upper surface of the nanocrystalline phosphor layer is covered with a resin and the like to protect the nanocrystalline phosphor from oxygen and water, molecules constituting the resin form a network and gaps are present in the resin. Therefore, when this structure is exposed to water vapor and water molecules, the water molecules enter the gaps and diffuse, which may lead to degradation of the nanocrystalline phosphor. Furthermore, if the resin is cured without uniform dispersion of the nanocrystalline phosphor, the good light emission balance cannot be achieved, which causes color unevenness.

Thus, the present invention has been made in light of the above-described problem and another object of the present invention is to realize a long-life light emitting device in which performance deterioration and degradation of the nanocrystalline phosphor are prevented and color unevenness is reduced.

A phosphor plate according to the present invention is a phosphor plate including a base material, a phosphor and a scattering material. The phosphor absorbs primary light emitted by a light emitting element and emits secondary light having a wavelength longer than a wavelength of the primary light. The scattering material scatters the primary light and the secondary light. An average distance from one surface of the phosphor plate to the phosphor is longer than an average distance from the one surface to the scattering material.

Preferably, the phosphor plate is formed of a plurality of layers including at least: a scattering layer containing the scattering material; and a phosphor layer containing the phosphor. Preferably, a specific gravity of the scattering material is different from a specific gravity of the phosphor.

Preferably, the phosphor has a particle size that is one-tenth or smaller of the wavelength of the primary light. Further preferably, the phosphor is a nanocrystalline phosphor. Further preferably, the nanocrystalline phosphor is formed of a III-V group compound semiconductor containing In and P or a II-VI group compound semiconductor containing Cd and Se. Further preferably, the nanocrystalline phosphor contains at least one of InP and CdSe.

A light emitting device according to one aspect of the present invention includes: a light emitting element; a package housing the light emitting element and having an opening on a light extraction side; and a phosphor plate provided at the opening. The phosphor plate includes a base material, a phosphor and a scattering material. The phosphor absorbs primary light emitted by the light emitting element and emits secondary light having a wavelength longer than a wavelength of the primary light. The scattering material scatters the primary light and the secondary light. An average distance from a primary light entrance surface of the phosphor plate to the phosphor is longer than an average distance from the primary light entrance surface to the scattering material. Preferably, the light emitting element is an LED.

A method for manufacturing a phosphor plate according to one aspect of the present invention includes the steps of: applying a first base material containing a scattering material onto a glass substrate; curing the first base material; applying a second base material containing a phosphor onto the first base material; and curing the second base material.

A method for manufacturing a phosphor plate according to another aspect of the present invention includes the steps of: applying a base material containing a scattering material and a phosphor onto a glass substrate; after the step of applying the base material, precipitating the scattering material in a lower part of the base material; and after the step of precipitating the scattering material, curing the base material. Preferably, a specific gravity of the scattering material is greater than a specific gravity of the phosphor.

According to the present invention described above, the light extraction efficiency can be enhanced in the light emitting device using the phosphor plate.

A light emitting device according to another aspect of the present invention includes: a light emitting element emitting primary light; and a wavelength conversion portion provided on the light emitting element, absorbing a part of the primary light and emitting secondary light. The wavelength conversion portion is formed of a wavelength conversion portion containing at least a nanocrystalline phosphor. A cover portion containing a particle made of an inorganic material is stacked on the wavelength conversion portion.

Preferably, the cover portion scatters light. Preferably, the inorganic material is an oxide. Preferably, the inorganic material is glass. Preferably, the particle made of the inorganic material has a particle size of 0.5 μm or larger and 10 μm or smaller.

Preferably, the nanocrystalline phosphor is formed of a III-V group compound semiconductor containing In and P or a II-VI group compound semiconductor containing Cd and Se. Further preferably, the nanocrystalline phosphor contains at least one of InP and CdSe.

According to the present invention described above, there can be realized a long-life light emitting device in which properties of the nanocrystalline phosphor are fully utilized, performance deterioration and degradation are prevented, and color unevenness is reduced.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a cross-sectional view of a light emitting device according to a first embodiment of the present invention.

FIGS. 2A to 2C are diagrams showing steps of manufacturing a phosphor plate according to the first embodiment.

FIG. 3 is a cross-sectional view of a light emitting device according to a second embodiment of the present invention.

FIGS. 4A to 4C are diagrams showing steps of manufacturing a phosphor plate according to the second embodiment.

FIG. 5 is a cross-sectional view of a light emitting device according to a third embodiment of the present invention.

FIG. 6 is a cross-sectional view showing a light emitting device disclosed in PTL 1.

FIG. 7 is a cross-sectional view of a light emitting device according to a fourth embodiment of the present invention.

FIG. 8 is a diagram for describing a step of manufacturing the light emitting device according to the fourth embodiment.

FIG. 9 is a diagram for describing a step of manufacturing the light emitting device according to the fourth embodiment.

FIG. 10 is a graph showing a light emission spectrum of a light emitting device 510 according to the fourth embodiment.

FIG. 11 is a cross-sectional view of a light emitting device according to a fifth embodiment of the present invention.

FIG. 12 is a cross-sectional view of a light emitting device according to a sixth embodiment of the present invention.

FIG. 13 is a cross-sectional view showing a modification of a light emitting device 530 according to the sixth embodiment.

FIG. 14 is a cross-sectional view of a light emitting device according to a seventh embodiment of the present invention.

FIG. 15 is a cross-sectional view showing a modification of a light emitting device 540 according to the seventh embodiment.

FIG. 16 is a schematic cross-sectional view of a light emitting device disclosed in PTL 2.

### DESCRIPTION OF THE PREFERRED EMBODIMENTS

Embodiments of the present invention will be described hereinafter with reference to the drawings. The embodiments are provided by way of example and it is also possible to combine the configurations as appropriate. In the drawings referenced below, the same reference characters indicate the same or corresponding portions. In this specification, “nanocrystal” refers to a crystal whose crystal size is decreased to approximately the exciton Bohr radius and in which confinement of an exciton and increase in bandgap due to the quantum size effect are observed.

### First Embodiment

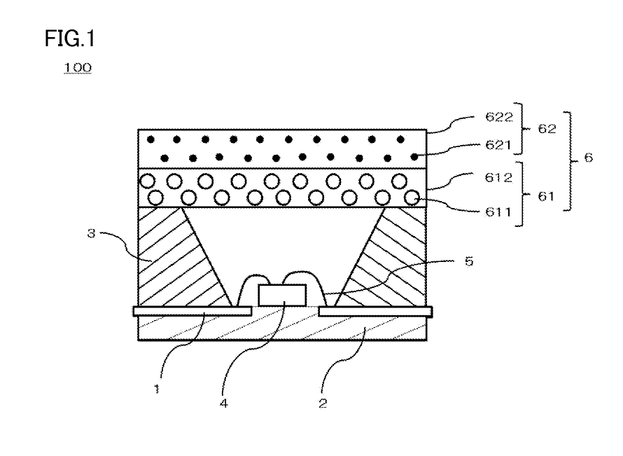

FIG. 1 is a cross-sectional view of a light emitting device 100 including a phosphor plate according to a first embodiment of the present invention. Light emitting device 100 includes a substrate 2 having an electrode 1 formed thereon, a package 3 and a light emitting element 4 provided on electrode 1, a wire 5 connecting light emitting element 4 and electrode 1, and a phosphor plate 6 arranged to face light emitting element 4. Phosphor plate 6 is formed by stacking a scattering layer 61 and a phosphor layer 62 in the order of closeness to light emitting element 4. Scattering layer 61 includes a scattering material 611 and a resin 612 containing scattering material 611 and serving as a base material. Phosphor layer 62 includes a phosphor 621 and a resin 622 containing phosphor 621 and serving as a base material.

Light emitting device 100 shown in FIG. 1 includes a red nanocrystalline phosphor and a green nanocrystalline phosphor excited by blue primary light from light emitting element 4. By mixing the blue primary light that is not used as the excitation light and secondary light from each phosphor, white light is obtained.

A conductor forming electrode 1 functions as an electrically conductive path for electrically connecting light emitting element 4, and is electrically connected to light emitting element 4 by wire 5. A metalized layer containing metal powder such as, for example, W, Mo, Cu or Ag can be used as the conductor.

Substrate 2 is required to have a high thermal conductivity and a high reflectivity. Therefore, in addition to a ceramic material such as alumina and aluminum nitride, a polymer resin into which a metal oxide fine particle is dispersed is, for example, suitably used for substrate 2.

Package 3 has a high reflectivity and is made of polyphthalamide and the like.

Light emitting element 4 is used as a light source. Light emitting element 4 preferably has a peak wavelength ranging from 360 nm to 470 nm A GaN-based LED, a ZnO-based LED, an organic EL or the like having a peak wavelength of, for example, 450 nm can be used as light emitting element 4.

A particle made of an inorganic material with a high refractive index is used as scattering material 611 forming scattering layer 61. For example, aluminum oxide, titanium oxide, silicon oxide or the like is used. Although the shape of the scattering material is not particularly limited, the commonly-used bead shape is preferable, and as for the size thereof, the scattering material preferably has a particle size that is about ten times as large as a wavelength of the primary light from light emitting element 4. Resin 612 is made of a translucent resin material such as silicone. Resin materials other than silicone can also be used as long as they are resins into which scattering material 611 is uniformly dispersed and are transparent resins resistant to heat and light.

Any phosphors can be used as phosphor 621 forming phosphor layer 62. For example, a rare earth-activated phosphor, a transition metal element-activated phosphor, or a phosphor formed of a III-V group compound semiconductor or a II-VI group compound semiconductor can be used.

As for the size of the phosphor, it is desirable that the phosphor should have a particle size that is one-tenth or smaller of the wavelength of the primary light. A reason for this will be described. The phosphor having a particle size that is one-tenth or smaller of the wavelength of the primary light has a size that is one-tenth or smaller of the wavelength in the visible light range (380 to 780 nm) and hardly causes Mie scattering. Therefore, the phosphor has an advantage that the secondary light emitted by a phosphor is not backscattered by another phosphor and the light extraction efficiency is enhanced. Further, a phosphor having a particle size of 40 nm or smaller is particularly preferable.

Further, a nanocrystal is preferably used as the phosphor. For example, an InP-based nanocrystal is used. As for InP, by decreasing a particle size thereof, a bandgap can be controlled within the range from blue (short wavelength) to red (long wavelength) due to the quantum size effect and colors of emitted light can be freely changed. Furthermore, by optimizing the fabrication conditions, variations in size distribution of the nanocrystal are eliminated and the nanocrystalline phosphor having a substantially uniform particle size is obtained. As a result, a thin light emission spectrum can be obtained.

In addition to the above, a nanocrystalline phosphor formed of the III-V group compound semiconductor other than InP or the II-VI group compound semiconductor may be used as the phosphor material. As for the binary nanocrystalline compound semiconductor formed of the III-V group compound semiconductor or the II-VI group compound semiconductor, for example, the II-VI group compound semiconductor includes CdS, CdSe, CdTe, ZnS, ZnSe, ZnTe, HgS, HgSe, HgTe, PbSe, PbS and the like, and the III-V group compound semiconductor includes GaN, GaP, GaAs, MN, AlP, AlAs, InN, InP, InAs and the like.

The ternary and quaternary compound semiconductors include CdSeS, CdSeTe, CdSTe, ZnSeS, ZnSeTe, ZnSTe, HgSeS, HgSeTe, HgSTe, CdZnS, CdZnSe, CdZnTe, CdHgS, CdHgSe, CdHgTe, HgZnS, HgZnSe, HgZnTe, CdZnSeS, CdZnSeTe, CdZnSTe, CdHgSeS, CdHgSeTe, CdHgSTe, HgZnSeS, HgZnSeTe, HgZnSTe, GaNP, GaNAs, GaPAs, AlNP, AlNAs, AlPAs, InNP, InNAs, InPAs, InGaN, GaAlNP, GaAlNAs, GaAlPAs, GaInNP, GaInNAs, GaInPAs, InAlNP, InAlNAs, InAlPAs and the like.

A nanocrystal containing In and P or a nanocrystal containing Cd and Se is preferably used as phosphor 621. This is because the nanocrystal containing In and P or the nanocrystal containing Cd and Se is easy to have a particle size that allows light emission in the visible light range (380 nm to 780 nm). Among them, InP or CdSe is particularly preferably used. This is because the number of materials forming InP and CdSe is small and fabrication is easy. In addition, InP and CdSe are materials showing a high quantum yield and shows high light emission efficiency when InP and CdSe are irradiated with the light from the LED. The quantum yield herein refers to a ratio of the number of photons emitted as fluorescence to the number of photons absorbed. Further, InP that does not contain highly toxic Cd is preferably used as phosphor 621.

Resin 622 is made of a translucent resin material such as silicone. Resin materials other than silicone can also be used as long as they are resins into which phosphor 621 is uniformly dispersed and are transparent resins resistant to heat and light.

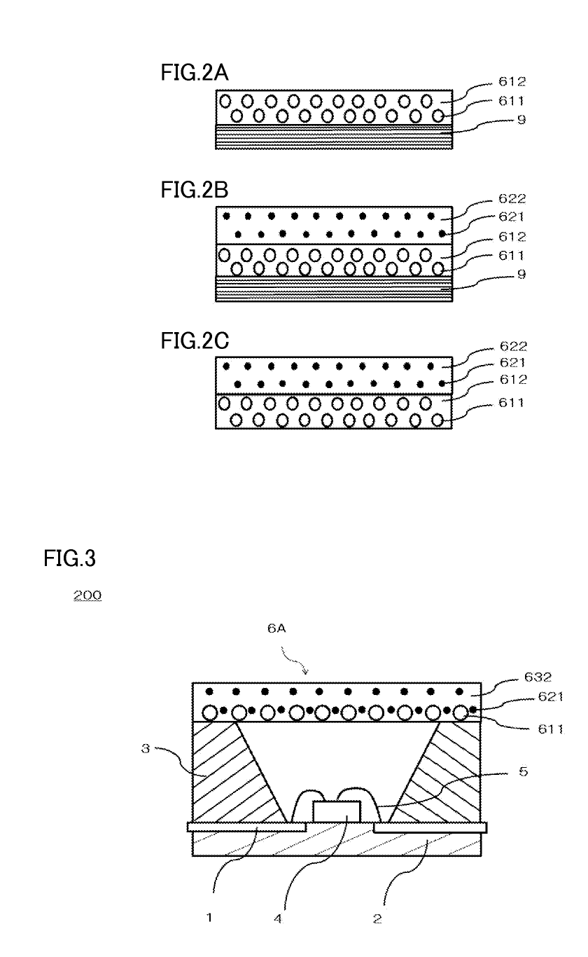

Next, a method for manufacturing phosphor plate 6 will be described with reference to FIG. 2. First, as shown in FIG. 2A, resin 612 containing only scattering material 611 is applied onto a glass substrate 9 to have a thickness of 100 to 500 μm. Resin 612 is allowed to stand for a prescribed time period and cured, thereby fabricating scattering layer 61. A ratio between resin 612 and scattering material 611 is set to be 10:1 in terms of ratio by weight. Aluminum oxide is used as scattering material 611, and a silicone resin (SCR1011 manufactured by Shin-Etsu Chemical Co., Ltd.) is used as resin 612. Resins other than SCR1011 can also be used as long as they are resins into which scattering material 611 is uniformly dispersed and are transparent resins resistant to heat and light.

After resin 612 is cured, as shown in FIG. 2B, resin 622 containing only phosphor 621 in a prescribed amount is applied onto scattering layer 61 to have a thickness of, for example, 100 to 500 μm. Resin 622 is allowed to stand for a prescribed time period and cured, thereby fabricating phosphor layer 62. A ratio between resin 622 and phosphor 621 is set to be 10:1 in terms of ratio by weight. An InP nanocrystalline phosphor that emits red light (hereinafter referred to as red nanocrystalline phosphor) and an InP nanocrystalline phosphor that emits green light (hereinafter referred to as green nanocrystalline phosphor) are used at a ratio by weight of 1:20 as phosphor 621. A silicone resin similar to the above is used as resin 622. Resins other than SCR1011 can also be used as long as they are resins into which phosphor 621 is uniformly dispersed and are transparent resins resistant to heat and light.

In the present embodiment, scattering layer 61 and phosphor layer 62 are applied to have substantially the same thickness. The thickness of each layer may, however, be adjusted as appropriate, depending on specifications of required light. For example, when the light is scattered more strongly, scattering layer 61 is applied to have a larger thickness. The ratio between scattering material 611 and resin 612, the ratio between phosphor 621 and resin 622, or the ratio between the red nanocrystalline phosphor and the green nanocrystalline phosphor may also be adjusted as appropriate, depending on specifications of required light. For example, when reddish light is desired, an amount of the red nanocrystalline phosphor may be increased.

After resin 622 is cured, as shown in FIG. 2C, glass substrate 9 is peeled away from phosphor plate 6, thereby fabricating phosphor plate 6. Phosphor plate 6 may be sandwiched between glass substrate 9 and another glass substrate, without peeling glass substrate 9 away. By sandwiching phosphor plate 6 between the two glass substrates, phosphor plate 6 can be protected from oxygen and water, and thus, degradation of phosphor plate 6 can be prevented.

As shown in FIG. 1, phosphor plate 6 fabricated in accordance with the above-described procedure is attached to the LED package including light emitting element 4, such that scattering layer 61 is located on the surface side close to light emitting element 4. A GaN-based LED having a peak wavelength of 450 nm is used as light emitting element 4. Since phosphor plate 6 is attached to the LED package such that scattering layer 61 is located on the side close to light emitting element 4 as described above, an average distance from an entrance surface of the primary light emitted from light emitting element 4 to phosphor 621 becomes longer than an average distance from the primary light entrance surface to scattering material 611. With such a configuration, scattering material 611 is not present in a light path of light traveling toward the light exit surface side of phosphor plate 6, of light emitted from phosphor 621, and thus, the light from phosphor 621 never returns to the primary light entrance surface side of phosphor plate 6 because of scattering material 611. As a result, the light extraction efficiency can be enhanced. As a method for measuring a distance from the primary light entrance surface to the phosphor or from the primary light entrance surface to the scattering material, there is, for example, a method for observing cross sections of the phosphor plate at a plurality of locations by means of an SEM (scanning electron microscope) and measuring a linear distance from the primary light entrance surface to the center of the phosphor or the scattering material.

Light traveling toward the primary light entrance surface side of phosphor plate 6, of the secondary light emitted by the nanocrystalline phosphor excited by the primary light from light emitting element 4, is scattered by scattering material 611 and travels toward the light exit surface side of phosphor plate 6. Furthermore, since the nanocrystalline phosphor has a particle size that is one-tenth or smaller of the wavelength of the primary light and does not scatter the secondary light (Mie scattering), the secondary light traveling toward the light exit surface side of phosphor plate 6 is not scattered toward the primary light entrance surface side and is outputted from phosphor plate 6. Therefore, the extraction efficiency of the light emitted by phosphor 621 can be enhanced.

Although two types of phosphors, that is, the red phosphor and the green phosphor, are used in the present embodiment, the present invention is not limited thereto. One type of phosphor or three or more types of phosphors may be used. The type, the number of types, an amount, a ratio and the like of the used phosphor may be adjusted as appropriate, depending on chromaticity of required light.

### Second Embodiment

Next, a second embodiment will be described. The present embodiment differs from the first embodiment in that a phosphor plate is formed of one resin layer.

FIG. 3 is a cross-sectional view of a light emitting device 200 including a phosphor plate 6A according to the second embodiment. Phosphor plate 6A used in light emitting device 200 includes phosphor 621 and scattering material 611 as well as a resin 632 containing phosphor 621 and scattering material 611 and serving as a base material, and is formed as a single layer.

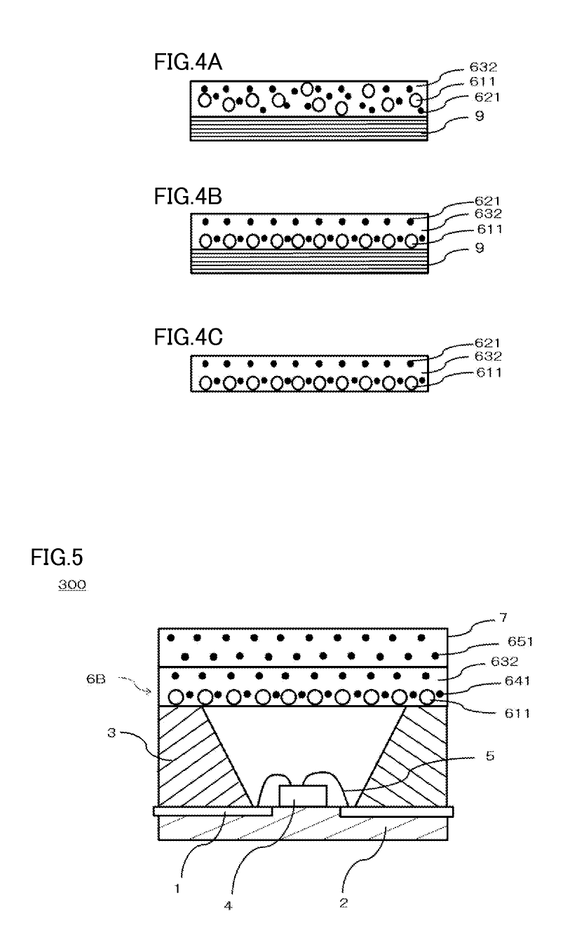

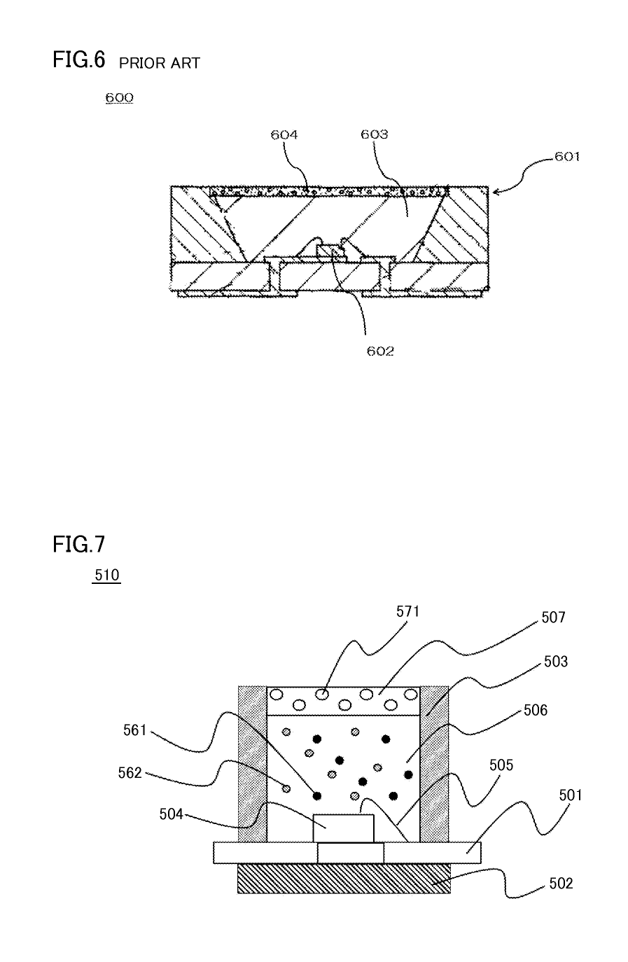

A process of manufacturing phosphor plate 6A will be described with reference to FIG. 4. First, as shown in FIG. 4A, resin 632 containing at least one or more types of phosphors 621 and scattering materials 611 in a prescribed amount is applied onto glass substrate 9 to have a thickness of, for example, 100 to 500 μm. A catalyst for promoting curing of resin 632 may be added. Aluminum oxide is used as scattering material 611. A specific gravity of scattering material 611 is preferably greater than a specific gravity of phosphor 621. The InP red nanocrystalline phosphor and the InP green nanocrystalline phosphor are used as phosphor 621, and the silicone resin (SCR1011 manufactured by Shin-Etsu Chemical Co., Ltd.) is used as resin 632. A viscosity of resin 632 is set to be 350 mPa·s under the environment at 23° C., and a ratio among resin 632, scattering material 611 and phosphor 621 is set to be 10:1:1 in terms of ratio by weight. Furthermore, the red nanocrystalline phosphor and the green nanocrystalline phosphor are used at a ratio by weight of 1:20 as phosphor 621.

Next, as shown in FIG. 4B, resin 632 is allowed to stand for a prescribed time period, and during curing of resin 632, the nanocrystalline phosphor lighter than scattering material 611 is uniformly dispersed. On the other hand, scattering material 611, whose precipitation speed is high because the specific gravity of scattering material 611 is greater than the specific gravity of the phosphor, is precipitated in a lower part of resin 632. Thus, there is obtained a plate member in which the nanocrystalline phosphor is substantially uniformly dispersed above scattering material 611 and only scattering material 611 is precipitated in the lower part of resin 632. After resin 632 is cured, as shown in FIG. 4C, glass substrate 9 is peeled away from resin 632, thereby fabricating phosphor plate 6A. Phosphor plate 6A may be sandwiched between glass substrate 9 and another glass substrate, without peeling glass substrate 9 away. By sandwiching phosphor plate 6A between the two glass substrates, phosphor plate 6A can be protected from oxygen and water, and thus, degradation of phosphor plate 6A can be prevented.

A silicone resin having such a viscosity that the nanocrystalline phosphor is substantially uniformly dispersed without precipitation and scattering material 611 is precipitated is used herein as the silicone resin. However, a lower-viscosity silicone resin that allows both the nanocrystalline phosphor and scattering material 611 to be precipitated may also be used. In this case, scattering material 611 having a greater specific gravity than the specific gravity of the nanocrystalline phosphor is precipitated earlier because of its high precipitation speed, and the nanocrystalline phosphor is precipitated later. As a result, most of scattering material 611 is precipitated in the lower part of resin 632 and the nanocrystalline phosphor is precipitated above scattering material 611. Therefore, there can be fabricated a phosphor plate in which the nanocrystalline phosphor and scattering material 611 achieve the substantially stacked layer state spontaneously.

As shown in FIG. 1, phosphor plate 6A fabricated in accordance with the above-described procedure is attached to the LED package including light emitting element 4, such that a surface containing more scattering materials 611 is located on the surface side close to light emitting element 4.

With such a configuration of light emitting device 200, the process of manufacturing phosphor plate 6A can be simplified. Particularly when a phosphor of a small specific gravity such as the nanocrystalline phosphor is used as phosphor 621, this configuration is highly effective. This configuration can also be realized by adjusting the specific gravity of scattering material 611 to be greater than the specific gravity of phosphor 621, without using the nanocrystalline phosphor.

Although the specific gravity of scattering material 611 is greater than the specific gravity of phosphor 621 in the present embodiment, the present invention is not limited thereto. Any methods may be used as long as scattering material 611 and phosphor 621 having different specific gravities are used, and scattering material 611 and phosphor 621 are separated and cured by using a difference in precipitation speed between scattering material 611 and phosphor 621.

### Third Embodiment

Next, a third embodiment will be described. The present embodiment is characterized in that a phosphor layer 7 containing another type of nanocrystalline phosphor is stacked on a phosphor plate 6B fabricated by using only a red nanocrystalline phosphor 641 in accordance with the method described in the second embodiment.

FIG. 5 is a cross-sectional view of a light emitting device 300 according to the third embodiment. In light emitting device 300, another type of phosphor layer 7 is stacked on phosphor plate 6B. Specifically, a resin containing a green nanocrystalline phosphor 651 is applied onto phosphor plate 6B containing red nanocrystalline phosphor 641. The resin is allowed to stand for a prescribed time period and cured, thereby fabricating phosphor layer 7. A thickness of phosphor plate 6B and a thickness of phosphor layer 7 containing nanocrystalline phosphor 651 that emits green light are set to be the same, and to be 100 to 500 μm.

Generally, a phosphor absorbs light having energy larger than the excitation energy and emits secondary light as fluorescence. Since the secondary light emitted by a phosphor with large excitation energy such as, for example, a blue phosphor is absorbed by a phosphor with small excitation energy such as, for example, a red phosphor, it is difficult to obtain a desired color balance. Therefore, by arranging the phosphor having a longer peak wavelength on the side close to light emitting element 4 that emits the primary light as in the present embodiment, the secondary light emitted by each phosphor is hardly absorbed again by the phosphors that emit the other colors, and the desired color balance can be easily obtained.

As described above, according to these embodiments, the extraction efficiency of the light emitted by the phosphor can be enhanced in the light emitting device using the phosphor plate.

It should be noted that the configurations of the phosphor plates and the light emitting devices described in the first to third embodiments may be combined as appropriate to configure a new phosphor plate and a new light emitting device.

### Fourth Embodiment

FIG. 7 is a cross-sectional view of a light emitting device 510 according to a fourth embodiment of the present invention. Light emitting device 510 is formed by stacking a substrate 502 having an electrode 501 formed thereon, a package 503 and a light emitting element 504 provided on electrode 501, a wire 505 connecting light emitting element 504 and electrode 501, a wavelength conversion portion 506 containing a semiconductor nanoparticle, and a cover portion 507 containing a particle made of an inorganic material (hereinafter referred to as inorganic particle). Wavelength conversion portion 506 and cover portion 507 are stacked in the order of a light path from light emitting element 504.

A conductor forming electrode 501 functions as an electrically conductive path for electrically connecting light emitting element 504, and is electrically connected to light emitting element 504 by wire 505. A metalized layer containing metal powder such as, for example, W, Mo, Cu or Ag can be used as the conductor. Substrate 502 is required to have a high thermal conductivity and a high total reflectivity. Therefore, in addition to a ceramic material such as alumina and aluminum nitride, a polymer resin into which a metal oxide fine particle is dispersed is, for example, suitably used for substrate 502.

Package 503 has a high reflectivity and is made of polyphthalamide and the like having good adhesion to a sealing resin. Light emitting element 504 is used as a light source. A GaN-based light emitting diode, a ZnO-based light emitting diode, a diamond-based light emitting diode or the like having a peak wavelength of, for example, 450 nm can be used as light emitting element 504.

An InP-based nanocrystal can be suitably used as wavelength conversion portion 506. As for InP, by decreasing a particle size thereof to nanosize by crystallization, a bandgap can be controlled within the range from blue to red due to the quantum size effect. For example, a red-light-emitting InP-based nanocrystalline phosphor having a wavelength of 620 to 750 nm and a particle size of about 2.7 to 5.0 nm is used as a red nanocrystalline phosphor 561, and a green-light-emitting InP-based nanocrystalline phosphor having a wavelength of 510 to 560 nm and a particle size of about 2.2 to 2.7 nm is used as a green nanocrystalline phosphor 562. A member obtained by mixing these phosphors into a silicone resin and curing the silicone resin can be used as wavelength conversion portion 506.

In addition to the above, a red nanocrystalline phosphor and a green nanocrystalline phosphor formed of the III-V group compound semiconductor other than InP or the II-VI group compound semiconductor may be used as wavelength conversion portion 506. As for the binary nanocrystalline compound semiconductor formed of the II-VI group compound semiconductor or the III-V group compound semiconductor, for example, the II-VI group compound semiconductor includes CdS, CdSe, CdTe, ZnS, ZnSe, ZnTe, HgS, HgSe, HgTe, PbSe, PbS and the like, and the III-V group compound semiconductor includes GaN, GaP, GaAs, AlN, AlP, AlAs, InN, InP, InAs and the like.

The ternary and quaternary compound semiconductors include CdSeS, CdSeTe, CdSTe, ZnSeS, ZnSeTe, ZnSTe, HgSeS, HgSeTe, HgSTe, CdZnS, CdZnSe, CdZnTe, CdHgS, CdHgSe, CdHgTe, HgZnS, HgZnSe, HgZnTe, CdZnSeS, CdZnSeTe, CdZnSTe, CdHgSeS, CdHgSeTe, CdHgSTe, HgZnSeS, HgZnSeTe, HgZnSTe, GaNP, GaNAs, GaPAs, AlNP, AlNAs, AlPAs, InNP, InNAs, InPAs, InGaN, GaAlNP, GaAlNAs, GaAlPAs, GaInNP, GaInNAs, GaInPAs, InAlNP, InAlNAs, InAlPAs and the like.

A nanocrystal containing In and P or a nanocrystal containing Cd and Se is preferably used as wavelength conversion portion 506. This is because the nanocrystal containing In and P or the nanocrystal containing Cd and Se is easy to have a particle size that allows light emission in the visible light range (380 nm to 780 nm).

Among them, InP or CdSe is particularly preferably used. This is because the number of materials forming InP and CdSe is small and fabrication is easy. In addition, InP and CdSe are materials showing a high quantum yield and shows high light emission efficiency when InP and CdSe are irradiated with the light from the LED. The quantum yield herein refers to a ratio of the number of photons emitted as fluorescence to the number of photons absorbed.

Further, InP that does not contain highly toxic Cd is preferably used as wavelength conversion portion 506.

A metal oxide particle or an inorganic oxide glass particle having a refractive index different from a refractive index of the resin into which inorganic particle 571 is mixed and kneaded is suitable as inorganic particle 571 contained in cover portion 507. This inorganic particle 571 is an inorganic material through which oxygen and water do not easily permeate, and includes, for example, silicon dioxide (SiO₂), yttrium oxide (Y₂O₃), gallium oxide (Ga₂O₃), aluminum oxide (Al₂O₃), titanium oxide (TiO₂) or the like. Such an oxide generally has properties of being resistant to heat, strong connection between molecules, and being stable. Among them, these oxides are particularly excellent in these properties and are available relatively easily.

Preferably, this inorganic particle 571 has an average particle size of 0.1 to 50 μm. More preferably, this inorganic particle 571 has an average particle size of 0.5 to 10 μm. Inorganic particle 571 may have a shape other than the granular shape. The metal oxide or the inorganic oxide glass takes on a property of scattering the light when an average particle size thereof becomes equal to or larger than the light emission wavelength of light emitting element 504 and the phosphor in wavelength conversion portion 506. In this case, the light emitted from light emitting element 504 and the phosphor is scattered by inorganic particle 571 in cover portion 507, and as a result, uniform light can be outputted from light emitting device 510. In addition, since such an inorganic particle is mixed and kneaded into the resin, external oxygen and water do not easily permeate through the resin, and thus, degradation of the nanocrystalline phosphor caused by arrival of oxygen and water at the phosphor can be prevented.

Not only a method for mixing one type of inorganic particle into the resin but also a method for mixing and kneading several types of inorganic particles described above or a method for stacking several layers made of different types of inorganic particles may be used. In each case, there is obtained an effect of suppressing permeation of air and water. Furthermore, the refractive index can be controlled. By adopting such a stacking order that the refractive index becomes lower with increasing proximity to the uppermost layer from the LED side, the extraction efficiency of the emitted light is enhanced.

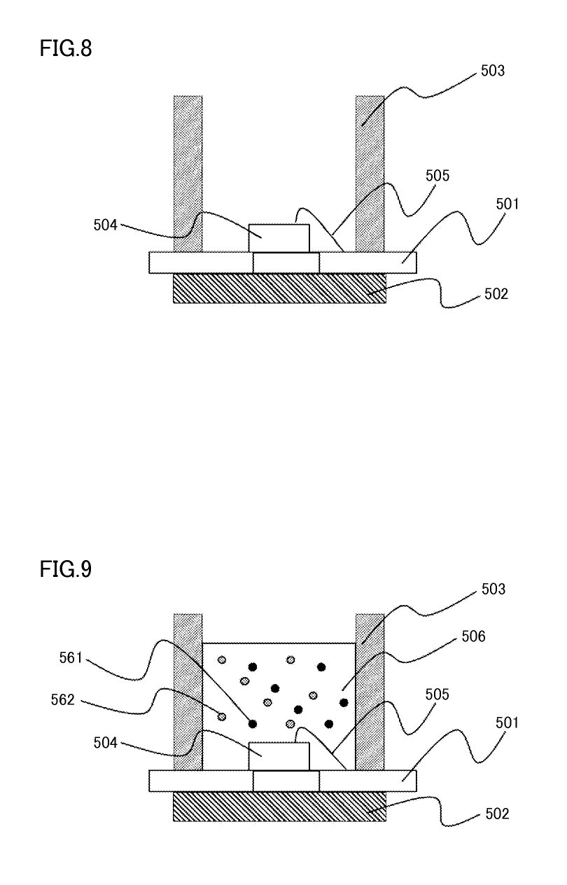

Next, one example of a method for manufacturing light emitting device 510 will be described hereinafter. FIGS. 8 and 9 are diagrams for describing steps of manufacturing light emitting device 510. First, as shown in FIG. 8, the LED package including electrode 501, substrate 502, package 503, light emitting element 504, and wire 505 is prepared.

Next, a resin and a toluene solution containing red nanocrystalline phosphor 561 and green nanocrystalline phosphor 562 are mixed such that a ratio among the resin, the red nanocrystalline phosphor and the green nanocrystalline phosphor is, for example, 1000:4.62:4.62 in terms of ratio by weight. A phosphor formed of an InP crystal is used as the red nanocrystalline phosphor and the green nanocrystalline phosphor. In addition, SCR1011 manufactured by Shin-Etsu Chemical Co., Ltd. is used as the silicone resin. Resins other than SCR1011 can also be used as long as they are resins into which the nanocrystalline phosphor is uniformly dispersed and are transparent resins resistant to heat and light. Then, as shown in FIG. 9, the resin containing red nanocrystalline phosphor 561 and green nanocrystalline phosphor 562 is put by drops into the LED package and is cured for a prescribed time period, thereby fabricating wavelength conversion portion 506.

Next, a resin and silicon dioxide serving as the inorganic particle are mixed such that a ratio between the resin and silicon dioxide is, for example, 1000:200 in terms of ratio by weight. SCR1011 manufactured by Shin-Etsu Chemical Co., Ltd. is used as the silicone resin. Resins other than SCR1011 can also be used as long as they are resins into which the silicon dioxide particle is uniformly dispersed and are transparent resins resistant to heat and light.

Thereafter, the resin containing the silicon dioxide particle as inorganic particle 571 is put by drops into the LED package having wavelength conversion portion 506, and is cured for a prescribed time period. In the case of SCR1011, natural curing is possible, although it takes time. Therefore, usually, it is desirable to heat the resin at 80° C. for 30 minutes, and then, heat the resin at 150° C. for approximately 2 hours to cure the resin. In addition to this method, a method for using a UV (ultraviolet) curable resin as the silicone resin and irradiating the resin with UV light to cure the resin, a method using a curing accelerator, and the like may be used.

Cover portion 507 containing inorganic particle 571 is fabricated in accordance with the above-described method. It is desirable that cover portion 507 should completely cover an upper surface of wavelength conversion portion 506. In addition, thicknesses of wavelength conversion portion 506 and cover portion 507 in a direction of the light path of the primary light may be set as appropriate, depending on the desired color and color balance. As described above, a lighting device 10 shown in FIG. 7 is fabricated. A manufacturing method is not limited to the above-described method as long as cover portion 507 containing inorganic particle 571 is formed on wavelength conversion portion 506.

As described above, cover portion 507 containing inorganic particle 571 serves to protect wavelength conversion portion 506 having the nanocrystalline phosphor. Therefore, there is no need to use a special cap such as a glass plate to protect the nanocrystalline phosphor from oxygen and water, which does not lead to an increase in the manufacturing steps. Thus, according to the present embodiment, the properties of the nanocrystalline phosphor can be fully utilized, the nanocrystalline phosphor can be protected from oxygen and water, degradation of the light emitting device can be prevented, and the light emitting device having excellent resistance can be efficiently obtained. In addition, since the light is scattered by inorganic particle 571, the light emitting device having reduced color unevenness can be obtained. In all steps of manufacturing the light emitting device, it is desirable to do work in the inert gas atmosphere such as a nitrogen gas in order to keep away from excess water and oxygen.

Now, a light emission spectrum of lighting device 10 fabricated in accordance with the above-described procedure is measured by a spectrophotometer MCPD-7000 manufactured by Otsuka Electronics Co., Ltd.

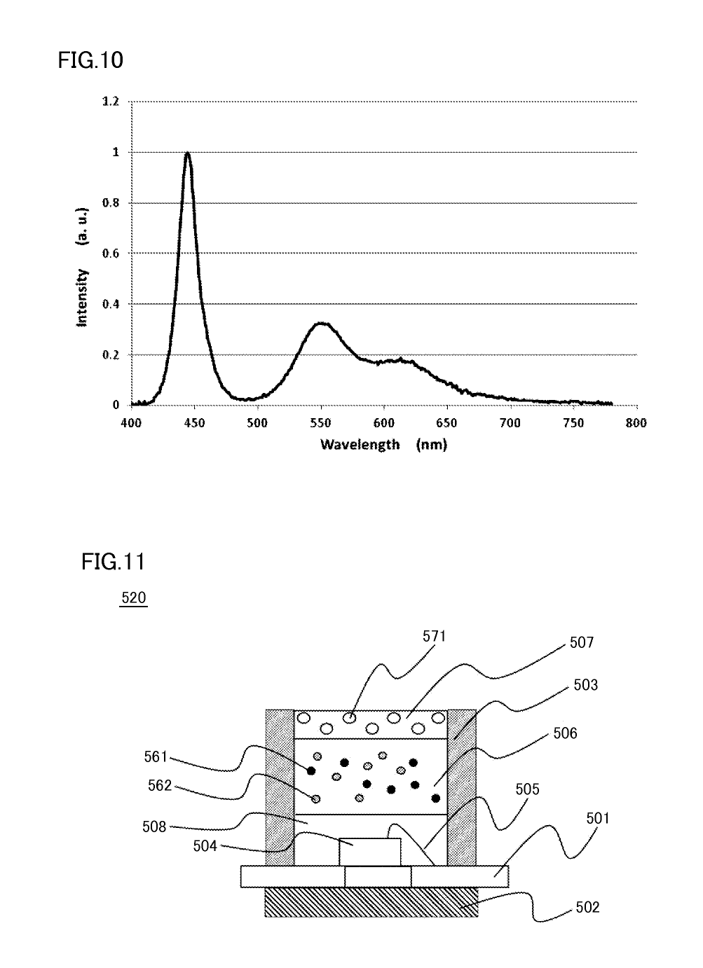

FIG. 10 is a graph showing the light emission spectrum of light emitting device 510. Since the red nanocrystalline phosphor and the green nanocrystalline phosphor are used, the thinner light emission spectrum is obtained than the light emission spectrum obtained when a conventional phosphor is used. In addition, an NTSC (National Television System Committee) ratio is enhanced and color reproducibility is improved as compared with conventional light emitting devices.

Although the method for fabricating light emitting device 510 formed only of wavelength conversion portion 506 and cover portion 507 containing inorganic particle 571 has been described in the present embodiment, a wavelength conversion portion containing another phosphor may be further stacked. The phosphor in each wavelength conversion portion absorbs all light having energy larger than the excitation energy and emits secondary light as fluorescence. Since the secondary light emitted by a phosphor (e.g., blue) with large excitation energy is absorbed by a phosphor (e.g., red) with small excitation energy, it is difficult to obtain the desired color balance. In such a case, by stacking the phosphors in descending order of peak wavelength along the light path of the primary light, the secondary light emitted by each phosphor is hardly absorbed again by the phosphors that emit the other colors, and the desired color balance can be easily obtained.

### Fifth Embodiment

Next, a fifth embodiment will be described. The present embodiment differs from the fourth embodiment in that a resin layer 508 is provided on light emitting element 504.

FIG. 11 is a cross-sectional view of a light emitting device 520 according to the fifth embodiment of the present invention. In light emitting device 520, resin layer 508, wavelength conversion portion 506 and cover portion 507 are stacked on light emitting element 504 in this order. Resin layer 508 is made only of a silicone resin (SCR1011 manufactured by Shin-Etsu Chemical Co., Ltd.) and is a layer that does not contain a nanocrystalline phosphor and an inorganic particle.

Since light emitting element 504 is covered with resin layer 508 as described above, degradation of the nanocrystalline phosphor mixed and kneaded into wavelength conversion portion 506 due to heat from light emitting element 504 can be prevented, in addition to the effects produced in the fourth embodiment.

### Sixth Embodiment

Next, a sixth embodiment will be described. The present embodiment differs from the fourth embodiment and the fifth embodiment in that wavelength conversion portion 506 is formed of a plurality of layers.

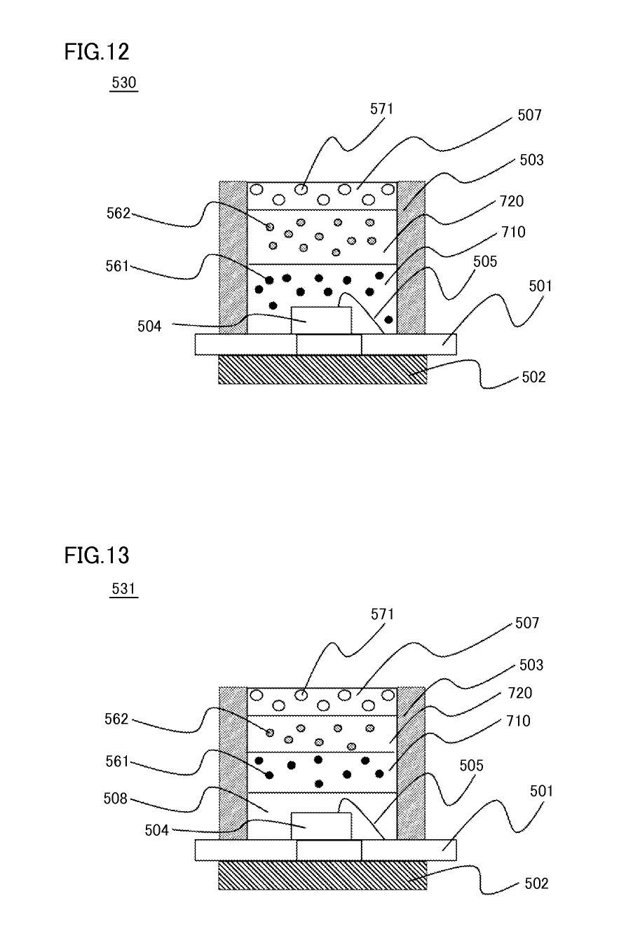

FIG. 12 is a cross-sectional view of a light emitting device 530 according to the sixth embodiment of the present invention. In light emitting device 530, a first wavelength conversion portion 710, a second wavelength conversion portion 720 and cover portion 507 are stacked on light emitting element 504 in this order. First wavelength conversion portion 710 is made of a silicone resin into which red nanocrystalline phosphor 561 is mixed and kneaded, and second wavelength conversion portion 720 is made of a silicone resin into which green nanocrystalline phosphor 562 is mixed and kneaded. By arranging the phosphor having a longer peak wavelength on the side close to light emitting element 504 that emits the primary light as described above, the following effect is produced in addition to the effects produced in the fourth embodiment: the secondary light emitted by each phosphor is hardly absorbed again by the phosphors that emit the other colors, and the desired color balance can be easily obtained.

As a modification, like a light emitting device 531 shown in FIG. 13, resin layer 508 that is made only of a silicone resin and does not contain a nanocrystalline phosphor and an inorganic particle may be stacked on light emitting element 504. With such a configuration, degradation of the nanocrystalline phosphor due to heat from light emitting element 504 can be prevented, in addition to the above-described effects.

### Seventh Embodiment

Next, a seventh embodiment will be described. The present embodiment differs from any of the above-described embodiments in that a phosphor layer is added on the light emitting element.

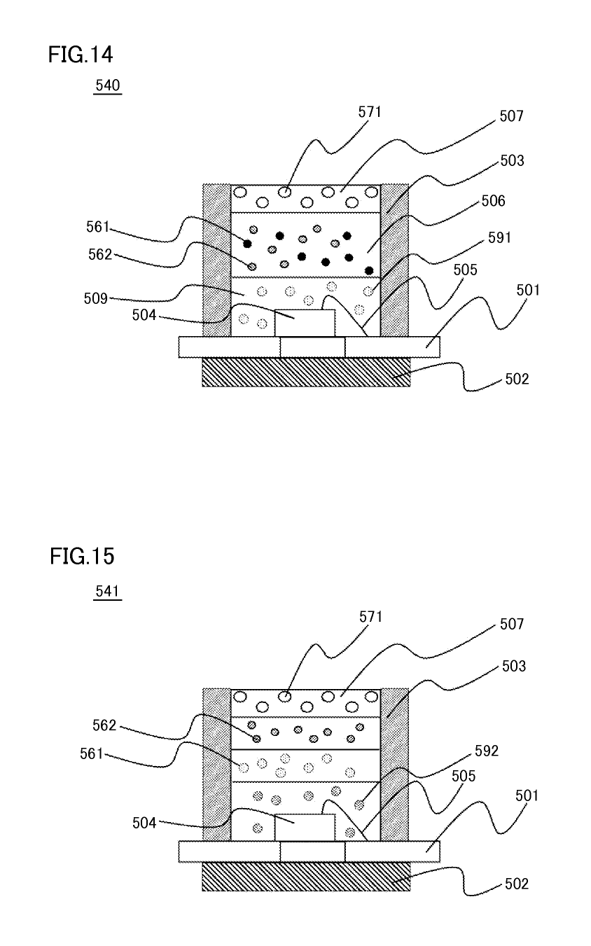

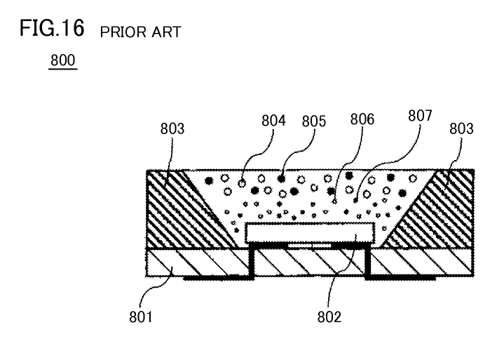

FIG. 14 is a cross-sectional view of a light emitting device 540 according to the seventh embodiment of the present invention. In light emitting device 540, a phosphor layer 509, wavelength conversion portion 506 and cover portion 507 are stacked on light emitting element 504 in this order. Phosphor layer 509 is made of a silicone resin into which a YAG:Ce phosphor is mixed and kneaded as a yellow phosphor 591. In addition, red nanocrystalline phosphor 561 and green nanocrystalline phosphor 562 are mixed and kneaded in wavelength conversion portion 506. Since phosphor layer 509 is stacked on light emitting element 504 as described above, degradation of the nanocrystalline phosphor due to heat from light emitting element 504 can be prevented. Moreover, the blue color of the primary light is blended in addition to the red color, the green color and the yellow color, and thus, white light having good color tone can be obtained. Furthermore, owing to cover portion 507, degradation of the nanocrystalline phosphor can be prevented and uniform light can be emitted.

As a modification, like a light emitting device 541 shown in FIG. 15, a phosphor having a longer peak wavelength may be arranged on the side close to light emitting element 504. In light emitting device 541 shown in FIG. 15, a CaAlSiN₃ red phosphor 592, yellow phosphor 591 and green nanocrystalline phosphor 562 are stacked on light emitting element 504. By arranging the phosphor having a longer peak wavelength on the side close to light emitting element 504 as described above, the secondary light emitted by each phosphor is hardly absorbed again by the phosphors that emit the other colors and the desired color balance can be easily obtained.

As described above, according to these embodiments, there can be realized a long-life light emitting device in which the properties of the nanocrystalline phosphor are fully utilized, performance deterioration and degradation are prevented, and color unevenness is reduced.

It should be noted that the configurations of the light emitting devices described in the fourth to seventh embodiments may be combined as appropriate to configure a new phosphor plate and a new light emitting device.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A phosphor plate including a base material, a phosphor and a scattering material, wherein
said phosphor absorbs primary light emitted by a light emitting element and emits secondary light having a wavelength longer than a wavelength of said primary light,
said scattering material scatters said primary light and said secondary light, and
an average distance from one surface of said phosphor plate to said phosphor is longer than an average distance from said one surface to said scattering material.

2. The phosphor plate according to claim 1, wherein
said phosphor plate is formed of a plurality of layers including at least:
a scattering layer containing said scattering material; and
a phosphor layer containing said phosphor.

3. The phosphor plate according to claim 1, wherein
a specific gravity of said scattering material is different from a specific gravity of said phosphor.

4. The phosphor plate according to claim 1, wherein
said phosphor has a particle size that is one-tenth or smaller of the wavelength of said primary light.

5. The phosphor plate according to claim 4, wherein
said phosphor is a nanocrystalline phosphor.

6. The phosphor plate according to claim 5, wherein
said nanocrystalline phosphor is formed of a III-V group compound semiconductor containing In and P or a II-VI group compound semiconductor containing Cd and Se.

7. The phosphor plate according to claim 6, wherein
said nanocrystalline phosphor contains at least one of InP and CdSe.

8. A light emitting device, comprising:
a light emitting element;
a package housing said light emitting element and having an opening on a light extraction side; and
a phosphor plate provided at said opening, wherein
said phosphor plate includes a base material, a phosphor and a scattering material,
said phosphor absorbs primary light emitted by said light emitting element and emits secondary light having a wavelength longer than a wavelength of said primary light,
said scattering material scatters said primary light and said secondary light, and
an average distance from a primary light entrance surface of said phosphor plate to said phosphor is longer than an average distance from said primary light entrance surface to said scattering material.

9. The light emitting device according to claim 8, wherein
said light emitting element is an LED.

10. A method for manufacturing a phosphor plate, comprising the steps of:
applying a first base material containing a scattering material onto a glass substrate;
curing said first base material;
applying a second base material containing a phosphor onto said first base material; and
curing said second base material.

11. A method for manufacturing a phosphor plate, comprising the steps of:
applying a base material containing a scattering material and a phosphor onto a glass substrate;
after the step of applying said base material, precipitating said scattering material in a lower part of said base material; and
after the step of precipitating said scattering material, curing said base material.

12. The method for manufacturing a phosphor plate according to claim 11, wherein
a specific gravity of said scattering material is greater than a specific gravity of said phosphor.

13. A light emitting device, comprising:
a light emitting element emitting primary light; and
a wavelength conversion portion provided on said light emitting element, absorbing a part of said primary light and emitting secondary light, wherein
said wavelength conversion portion is formed of a wavelength conversion portion containing at least a nanocrystalline phosphor, and
a cover portion containing a particle made of an inorganic material is stacked on said wavelength conversion portion.

14. The light emitting device according to claim 13, wherein
said cover portion scatters light.

15. The light emitting device according to claim 13, wherein
said inorganic material is an oxide.

16. The light emitting device according to claim 13, wherein
said inorganic material is glass.

17. The light emitting device according to claim 13, wherein
said particle made of said inorganic material has a particle size of 0.5 μm or larger and 10 μm or smaller.

18. The light emitting device according to claim 13, wherein
said nanocrystalline phosphor is formed of a III-V group compound semiconductor containing In and P or a II-VI group compound semiconductor containing Cd and Se.

19. The light emitting device according to claim 18, wherein
said nanocrystalline phosphor contains at least one of InP and CdSe.
